(19) United States
(12) Patent Application Publication
(10) Pub. No.: US 2005/0182925 A1
(43) Pub. Date: Aug. 18, 2005

(54) Multi-mode token

(76) Inventor: Yoshihiro Tsukamura, Riverside, CA (US)

Correspondence Address: VINCENT J. MUCCIONE;C/O VISCOT INDUSTRIES, INC., P.O. BOX 351, EAST HANOVER, NJ, 07936, US

(21) Appl. No.: 10/777,975

(22) Filed: Feb. 12, 2004

(51) Int. Cl. H04L 9/00

(52) U.S. Cl. 713/158

(57) ABSTRACT

A multi-mode cryptographic token that has at least one mode that allows for a certain period of time or number of operations to pass before requiring a user to logon. A predefined cryptographic operation is performed in each mode. Each mode has a predetermined expiration period or number of operations after which the most recent logon is no longer valid. The expiration date is compared with the present time obtained from the authenticator which requests the operation, or checked by the internal Mode Decrementing Counter, respectively.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to authentication token devices such as Integrated Circuit (IC) cards, Universal Serial Bus (USB) keys, Biometric Authentication devices, Remote Access Key Tokens, or Cellular Phones.

### BACKGROUND OF THE INVENTION

This invention provides multiple authentication modes for authentication devices such as IC Cards, USB keys, Biometric Authentication devices, Remote Access Key Tokens, or Cellular Phones depending on the situation.

Current conventional authentication token devices have at most two modes. One mode does not require a Personal Identification Number (PIN), Password or Biometrics such as a fingerprint or iris.

The other mode requires a PIN, Password or Biometrics at every event.

For many applications, it is inconvenient to only have these two modes available.

For example,

many companies would like employees to use a single IC card to pass through the physical gates, access computers, access the company's computer servers, access high security rooms, make small payments at the company cafeteria or make authorizations using digital signatures.

Each of these applications requires a different level of security and increasing security decreases user convenience.

### SUMMARY

The object of this invention, Multi-Mode Token, is to provide at least one mode that allows for a certain period of time or number of operations to pass before requiring a user to logon in order to balance security and convenience, solving the aforementioned problem [005].

### BRIEF DESCRIPTION OF THE PROCESS FLOW AND TABLES—FIGURES

FIG. 1 is a table of the notation used in this application.

FIG. 2 is the formulae of this application.

FIG. 3 is a block diagram of the system of this invention.

FIG. 4 is an example of the modes of this invention, Multi-Mode Token.

FIG. 5 is a table of Register and Counter values in a Multi-Mode Token.

FIG. 6 is a table of the basic user data stored on a Multi-Mode Token.

FIG. 7 is an example of multi-mode settings.

FIG. 8A is the initialization flow of a Multi-Mode Token.

FIG. 8B is the initialization flow of a Multi-Mode Token continued.

FIG. 9 is the flow of Multi-Mode Token logon.

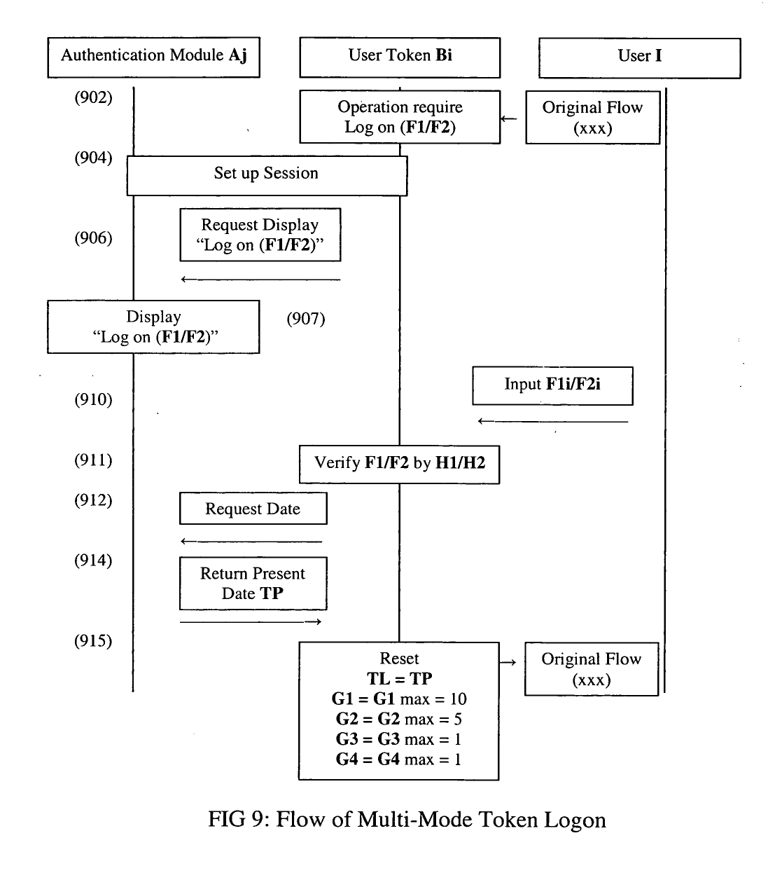

FIG. 10 is the flow of mode 1 operation.

FIG. 11 is the flow of mode 2, authentication.

FIG. 12 is the flow of mode 2, decryption.

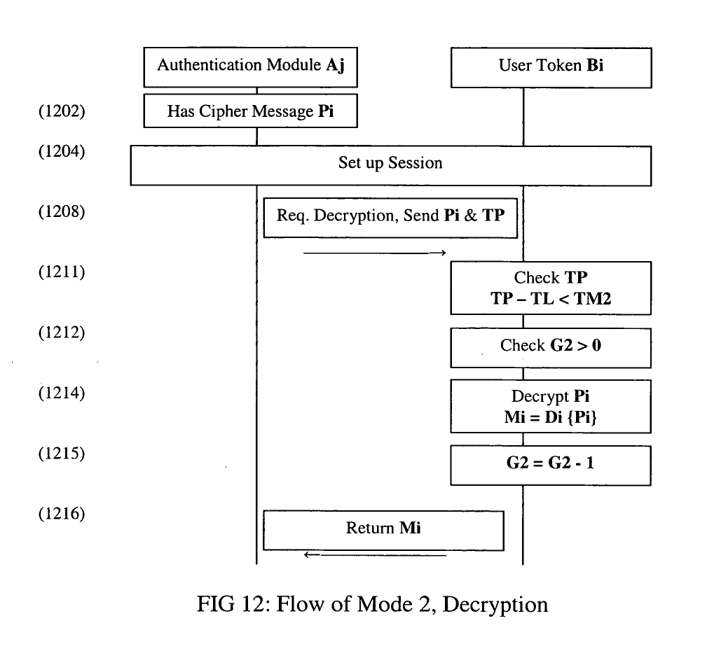

FIG. 13 is the flow of mode 2, payment.

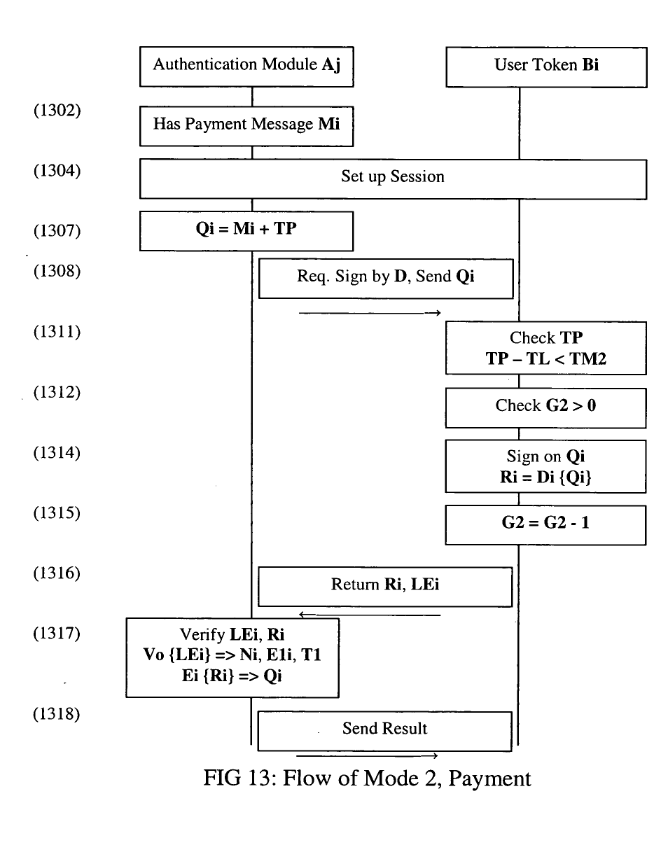

FIG. 14 is the flow of mode 3 payment/authorization

FIG. 15 is the flow of mode 4 payment/authorization.

### DETAILED DESCRIPTION

Notation

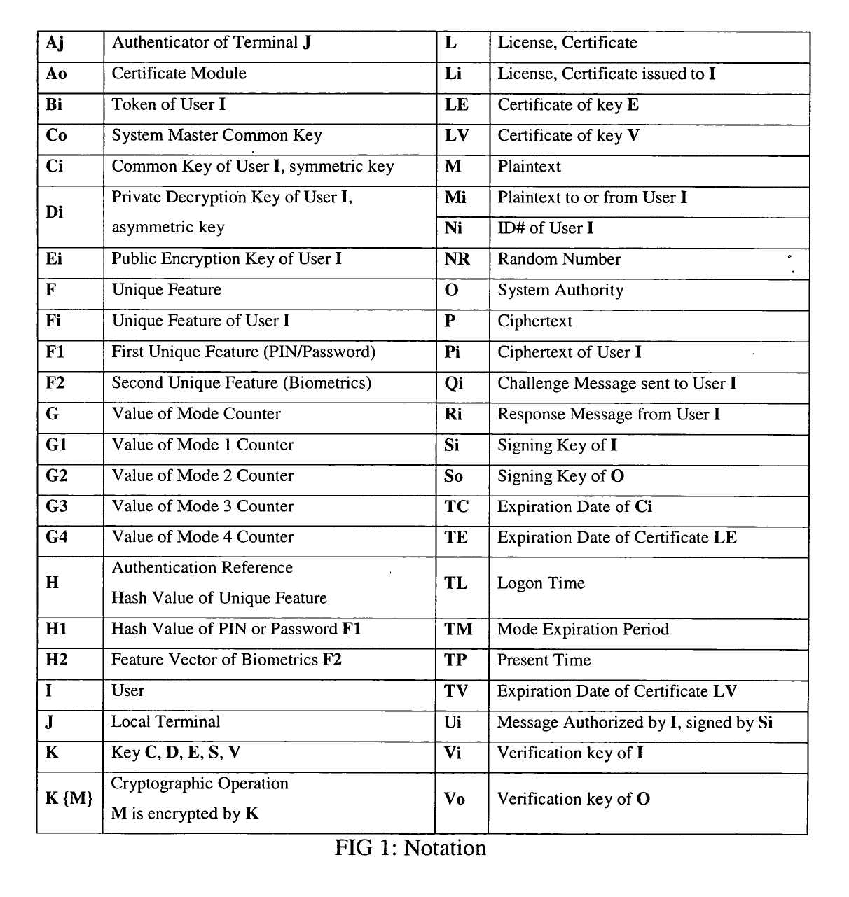

FIG. 1 outlines the notation used in this application. Bold uppercase letters represent entity names such as A, B, or items such as an ID# N, keys C, D, E or times TP, TL. Lowercase bold suffixes signify a relation to the relative entity.

Formulae

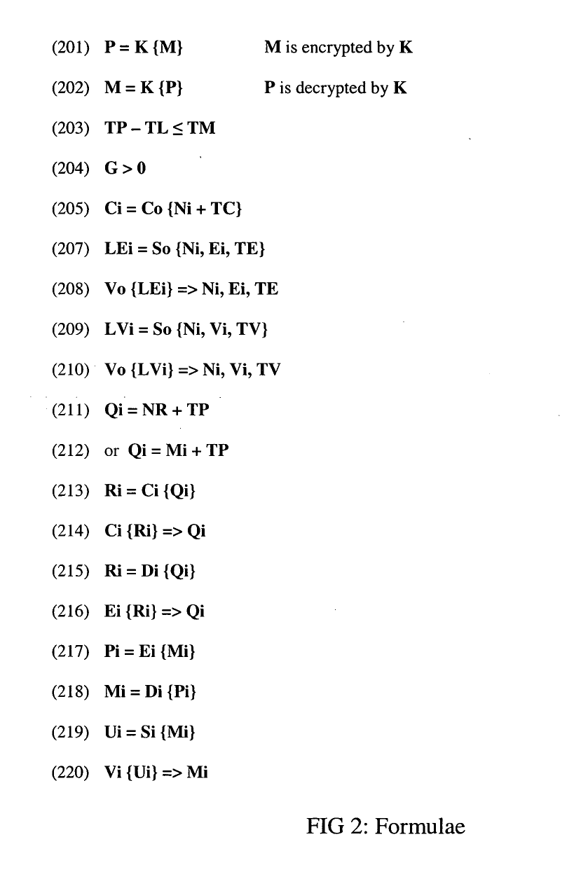

FIG. 2 lists all formulas used in this application.

System Block Diagram

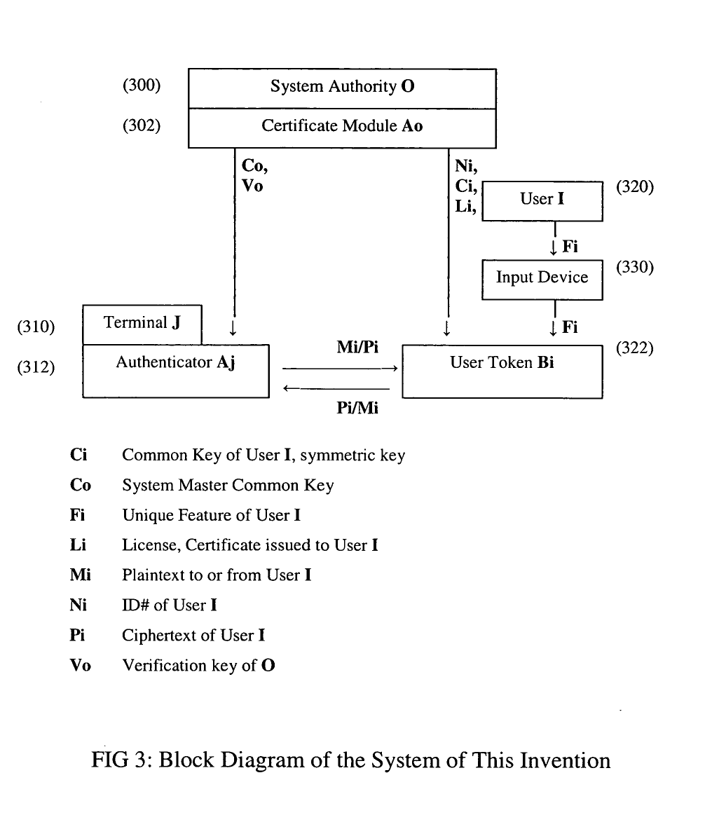

FIG. 3 provides an embodiment of the system of this invention in the form of a block diagram.

This system includes at least one authenticator module Aj (312) at a local system terminal J (310) and at least one authentication token Bi (322) owned by user I (320) and a certificate module Ao (302) at the system Authority O (300). Ao and Aj have a token interface.

User I can input his/her unique feature Fi into the token Bi via an input device (330). The unique feature Fi might be F1i: the user's PIN or password, or F2i: a biometric feature such as a fingerprint, hand shape, iris, face or voice.

In most cases, the input device (330) is provided by Terminal J, but some tokens include an integrated biometric sensor or keypad for PIN input.

Conventional System

Conventional token authentication systems have only two modes.

The first mode is used for relatively low security access and does not require users to log on to the token.

The second mode is used for higher security access and requires users to log on to the token using a unique feature Fi, such as a PIN, password or biometrics, at every session.

Examples of Problems with the Conventional System
a) Employees must possess a token in order to pass through the company entrance or parking gate.
It is too risky for employees to be allowed to pass through the gates using only a token because the token might be lost or stolen.
In this case, it is necessary to have at least a minimal relationship between users and their tokens.
But if all employees are required to log on at a physical gate, the gate would be jammed due to the time it takes for employees to log on.
In this case, one day is too short because every Monday morning the logon status of most tokens would be expired.
Therefore, it is desired that one logon be valid for one week at the company gates.
b) Employees use tokens to pay for meals at the company cafeteria.
Requiring employees to log on at each cafeteria counter is tedious and would cause lines to congest.
On the other hand, it is too risky to make logons valid for a week.
Therefore, it is desired that one logon be valid for one day in the company cafeteria.

Multi-Mode Token

In order to solve problems like the above [012], this invention provides a Multi-Mode Token.

It is ideal to use one token for multiple applications which all require different access security levels.

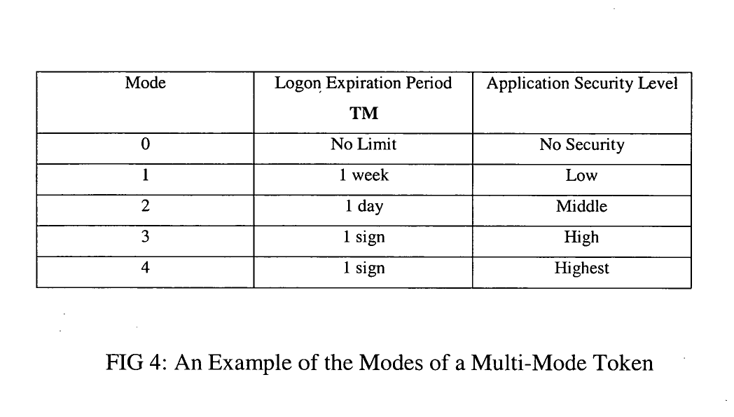

FIG. 4 illustrates one example of mode usage for multiple applications which all require different access security levels.

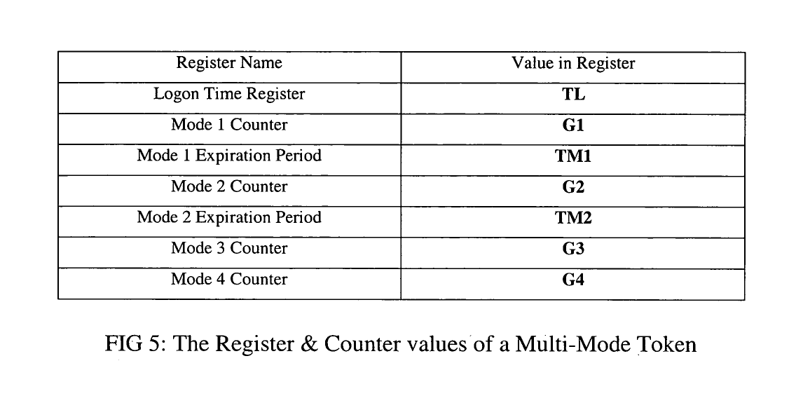

FIG. 5 shows the necessary register and counters that are used in a Multi-Mode Token.

The essential concept of this invention is to provide those registers in a token and to use them if required by the security level of the application.

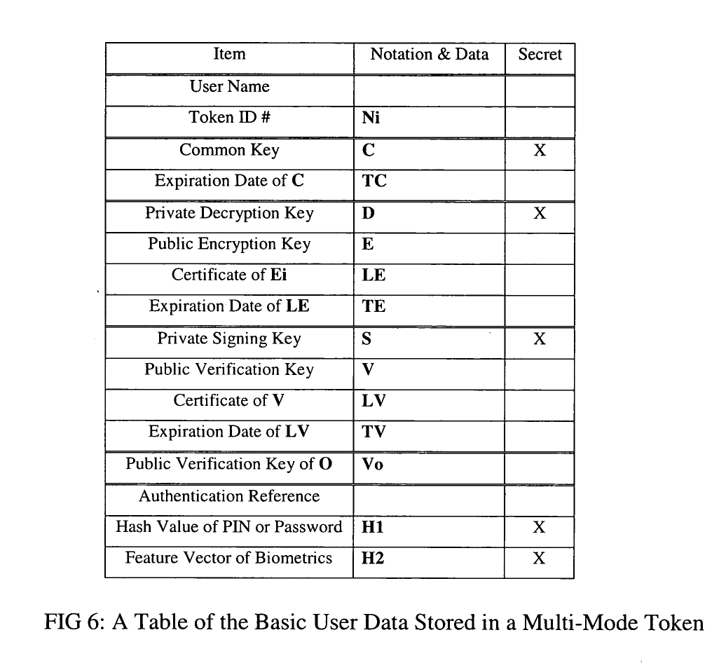

FIG. 6 shows a table of necessary data contained in a Multi-Mode Token.

Some of this data may be omitted depending on the system in which the token is used. The following sections describe how a token obtains and uses this data. The common key C, private decryption key D, private signing key S, hash value of the password H1, and the feature vector of biometrics H2 are kept secret and are used only in certain modes.

Mode Settings

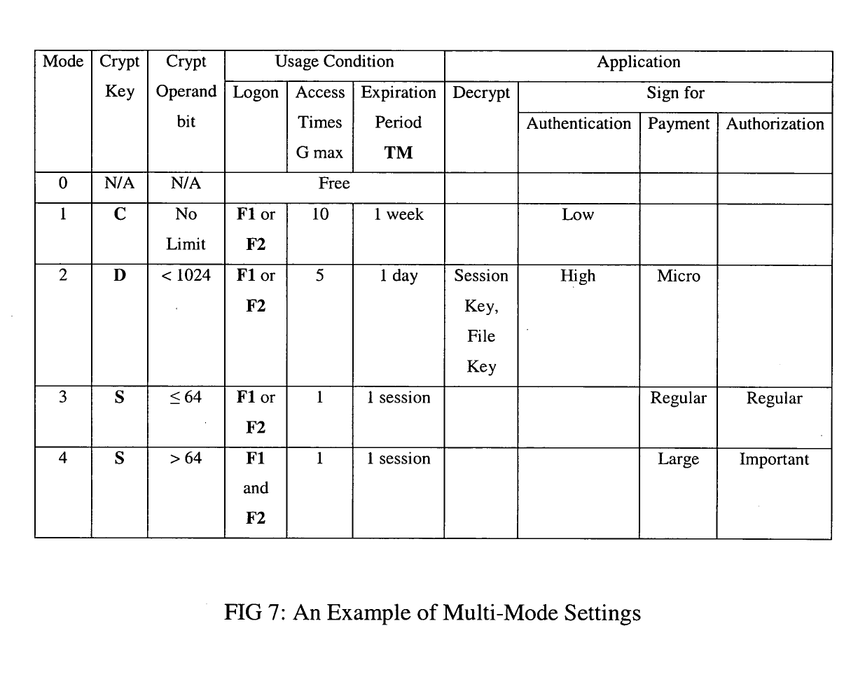

FIG. 7 provides a more detailed example of the mode settings seen in FIG. 4.

Users are not required to log on to the token for mode 0 operation, in which the application obtains the non-secret information seen in FIG. 6.

In the mode 1 operation for the relatively low security application, the common secret key C is used and user logon is required, which is valid for one week or for ten operations.

In the mode 2 operation for the second-level security application, the private decryption key D is used and user logon is required, which is valid for one day or for five operations.

In modes 1 and 2, the relationship between the Expiration Date Condition
TP−TL≦TM formula (203)
and the Access Times Condition
G>0 formula (204)
can be either the “OR” condition or the “AND” condition.

In the mode 3 operation for the high-level security application, user logon is required for every operation using S since the maximum of the G3 and G4 counters is 1, which is reduced by 1 at each operation using D or S.

In the mode 4 operation for the highest-level security application, two different types of logon, such as a password and fingerprint, are required for every operation using S.

G1, G2 and G3 are reset to G max at every logon using F1 or F2.

G4 is reset to 1 at every logon using F2 after G3 is reset by logging on with F1.

Initialization

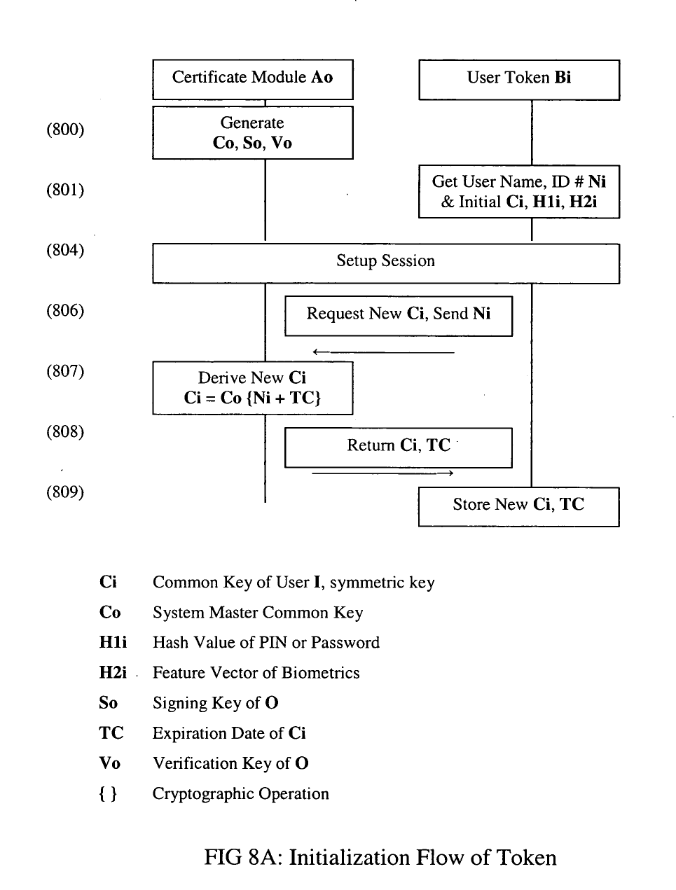

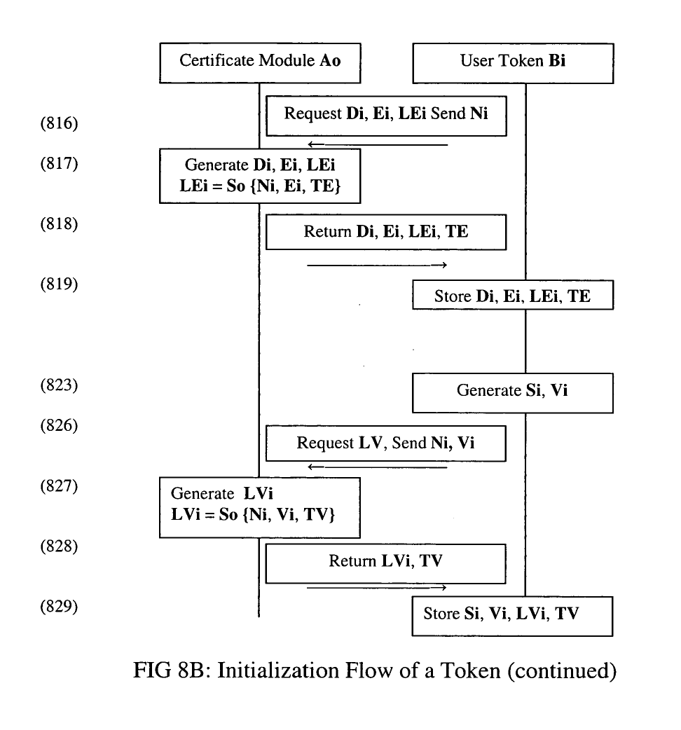

FIG. 8A shows the initialization flow of a token.

Initialization is performed by the certificate module Ao at the System Authority or System Administrator O.

Flow (800)—In preparation, Ao generates a System Master Common Key Co and a signing key pair So, Vo.

Flow (801)—User Token Bi obtains a User Name, a hash value of User Password H1i, feature vectors of User Biometrics H2i from User I by some secure means, and obtains ID# Ni and the initial Ci from Ao by some secure means.

Flow (804)—A session is setup between Ao and Bi.

Depending on the situation, the old Ci may be used as the session key for all secure communication within the initial session.

Flow (806)—Bi requests a new Ci from Ao, sending Ni in order to validate the token.

Flow (807)—Ao derives a new Ci using
Ci=Co{Ni+TC} formula (205)

The expiration date TC of the key Ci is embedded into Ci itself so that Ci cannot be used after that date.

Flows (808) and (809)—Ci and TC are returned to and stored on Bi. Ci is used in mode 1.

Flow (816)—In the next initialization step, Bi sends Ni to Ao and requests an asymmetric key pair Di, Ei and its certificate LEi.

Flow (817)—Ao generates the asymmetric key pair Di, Ei and its certificate LEi using
LEi=So{Ni, Ei, TE}. formula (207)

As formula (207) shows, LEi is a certificate issued by Ao to authorize and validate Ni and Ei until the expiration date TE.

Flow (818)—Ao returns Ei, LEi and TE to Bi. Ao also returns Di to Bi in secure manner such as wrapping it with the session key. Di is also escrowed by Ao.

Flow (819)—Bi stores Ei, LEi, TE and Di and uses them for session key exchange, decryption of file encryption keys, authentication at physical gates, or micro payments.

Flow (823)—Bi itself generates a key pair Si, Vi.

Si is a signing key and Vi is a verification key.

Flow (826)—Bi sends Ni and Vi to Ao and requests the certificate LVi.

Flow (827)—Ao calculates the certificate LVi using
LVi=So{Ni, Vi, TV} formula (209)

As formula (209) shows, LVi is a certificate issued by Ao to authorize and validate Ni and Vi until the expiration date TV.

Flows (828) and (829)—LVi and TV are returned to and stored on Bi. Si is used for important signing authorized by User I.

TM, G max and other Mode settings are configured by either User I or System Administrator O, depending on the system.

Token Logon

Flow (902)—When Bi requires user logon, it jumps from the original flow point to Flow (902).

Flows (904), (906) and (907)—After setting up a session, Bi requests that the Authentication Module or Application Module Aj of the Terminal J indicate “Logon (F1/F2)”.

The logon is performed using password F1, biometrics F2 or both depending on the required mode.

Flow (910)—According to the indication on the display of Terminal J, User I inputs his/her unique feature Fi via the input device (330).

Flow (911)—Bi verifies the user I's Unique Feature F1i or F2i using the stored User Authentication Reference H1i (Hash Value of Password) or H2i (Feature Vector of Biometrics).

If Fi is accepted,

Flow (912), (914)—Bi sends a “Request Date” command to Aj and obtains the Present Date TP. This is a unique command not found in the conventional token command set.

Flow (915)—Bi resets all registers and counters as shown below:

| Log on | Time | Register | TL = | TP |
|---|---|---|---|---|
| Mode | 1 | Counter | G1 = | G1 max = 10 |
| Mode | 2 | Counter | G2 = | G2 max = 5 |
| Mode | 3 | Counter | G3 = | G3 max = 1 |
| Mode | 4 | Counter | G4 = | G4 max = 1 |

The Logon Time Register is used to check the expiration date.

Mode Counters are used to count the number of operations. In modes 1 and 2, the relationship between the Expiration Period and the Mode Counter is either the “OR” condition or the “AND” condition, depending on the system.

Mode 1

As described in [015] and FIG. 7, Mode 1 is used for relatively low security applications such as authorizing physical access through the company entrance or parking gate.

The common secret key Ci is used for encryption or signing in Mode 1.

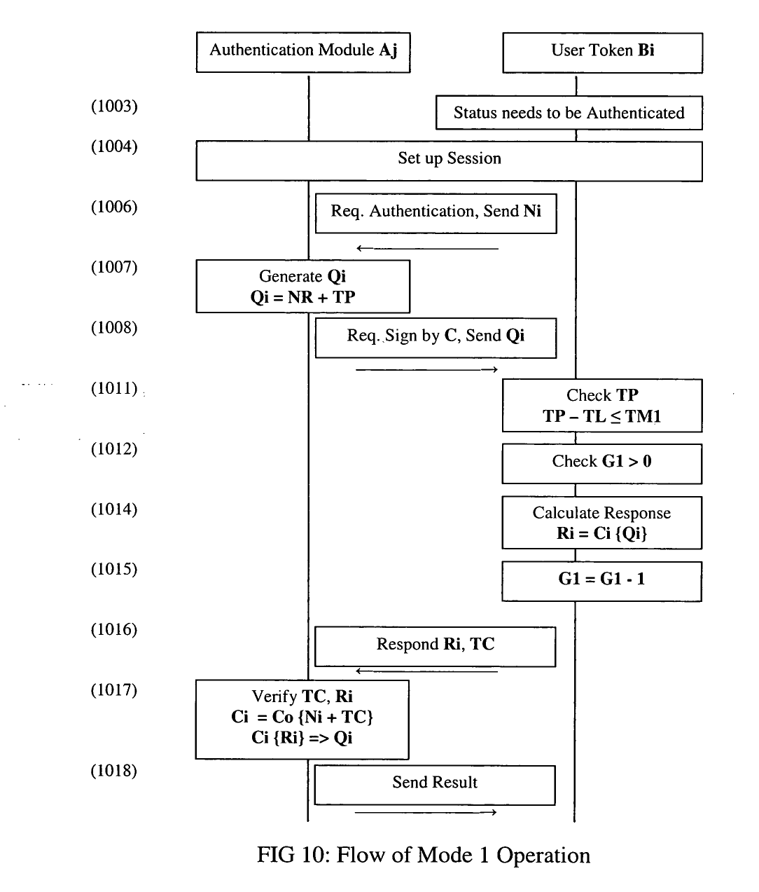

FIG. 10 shows an example of the main flow of Mode 1 operation.

Flows (1003), (1004) and (1006)—When User Token Bi needs to be authenticated, it sets up a session with Authentication Module Aj and sends its ID# Ni to Aj, requesting authentication.

Flow (1007)—Aj generates a challenge message Qi using
Qi=NR+TP formula (211)
which comprises a random number NR and the present time TP.

Flow (1008)—Aj sends Qi to Bi and requests that Bi sign Qi using the common secret key Ci.

Flow (1011)—Bi checks to see if the present time is before the expiration date using
TP−TL≦TM1 formula (203)
where
TP: Present Date
TL: The date of the last logon
TM1: Mode 1 expiration period

Flow (1012)—Bi also checks to see if the Mode 1 Counter G1 has been exceeded using
G1>0 formula (204)

Flow (1014)—If TP−TL≦TM1 and G1>0, then Bi calculates the response message Ri using
Ri=Ci{Qi}. formula (213)

Flow (1015)—Bi reduces the G1 Counter value by 1.

Flow (1016)—Bi returns the response message Ri and the expiration date TC of Ci to Aj.

Flow (1017)—Aj derives the secret common key Ci of Bi using
Ci=Co{Ni+TC} formula (205)
and verifies Qi with Ci using
Ci{Ri}→Qi. formula (214)

Flow (1018)—Aj sends the result to Bi: Accepted or Denied depending on the result of Flow (1017).

In this example flow, the relationship between TM1 and G1 is the “AND” condition.

However, the relationship between them can be the “OR” condition, or just one of them can be used, depending on the system requirement.

Mode 2, Authentication

Mode 2 is used for mid-level security applications such as the decryption of a session key, decryption of a file encryption key, the signing of a challenge response of authentication, or the signing of micro payments.

The private decryption key Di is used as a cryptographic key in Mode 2.

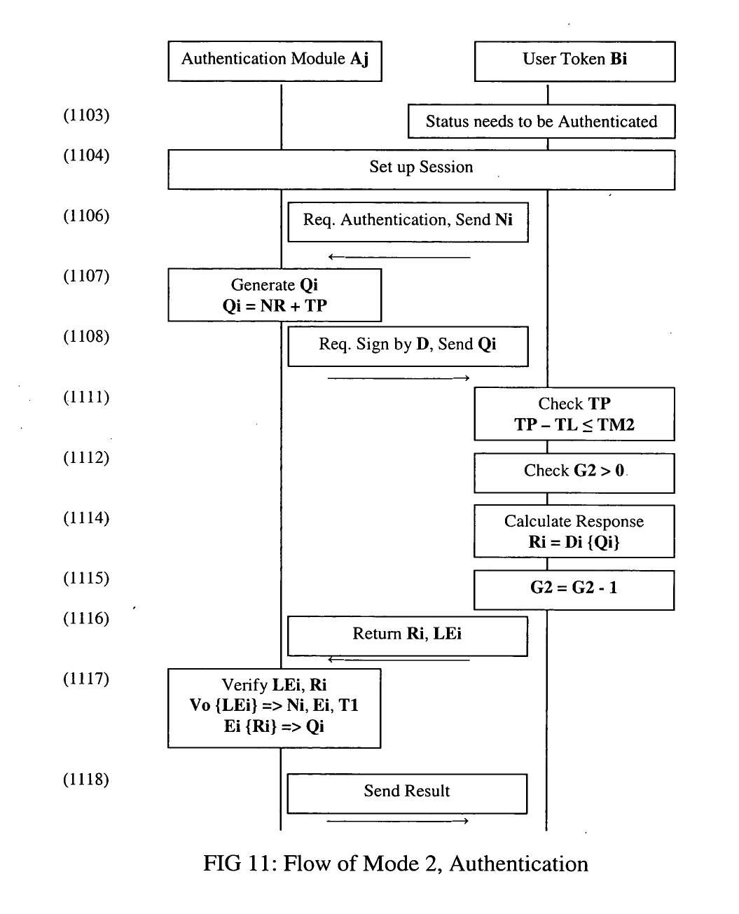

FIG. 11 shows an example of the main flow of a Mode 2 authentication operation.

Flows (1103), (1104), (1106) and (1107)—Up to Flow (1107), the flow is the same as in Mode 1.

Flow (1108)—Aj requests that Bi sign the challenge message Qi using the private decryption key Di (instead of Ci as in Mode 1).

Flows (1111), (1112), (1114) and (1115)—These flows are the same as in Mode 1 except

TM2 is used instead of TM1,

G2 is used instead of G1, and

Di is used instead of Ci.

Flow (1116)—Bi returns the response message Ri and the certificate LEi of the public encryption key Ei (instead of TC as in Mode 1).

Flow (1117)—Aj verifies LEi using
Vo{LEi}→Ni, Ei, TE formula (208)
and verifies Qi using Ei and
Ei{Ri}→Qi formula (216)

Flow (1118)—Aj sends the result to Bi: Accepted or Denied depending on the result of Flow (1117).

Mode 2, Decryption

This operation is used to decrypt a session key or unwrap a file encryption key.

Flow (1202)—An Application Module or Authentication Module Aj has Pi, the ciphertext of the session key or file key K encrypted by Ei using
Pi=Ei{K}. formula (217)

Flow (1208)—Aj sends Pi and the present time TP to Bi and requests that Bi decrypt Pi with Di.

Flows (1211), (1212), (1214) and (1215)—These flows are the same as in FIG. 11 except

Pi is used instead of Qi, and

Mi is used instead of Ri.

Flow (1216)—Bi returns the plaintext Mi to Aj.

In this case Mi is the key K.

Mode 2, Payment

This operation is used to authorize a micro payment (e.g. less than $10).

Flow (1302)—Aj has a payment message (or its hash value) Mi which must be authorized by User I.

Flow (1307)—Aj generates a challenge message Qi using
Qi=Mi+TP formula (212)

These flows are the same is in FIG. 11 except that the payment message Mi is used instead of a random number NR as in Flow (1107).

Mode 3 Payment/Authorization

Mode 3 is used for high security applications such as signing a payment or making an authorization which cannot be denied later.

Flow (1402)—Aj has a message (or its hash value) Mi which must be authorized by User I.

Flow (1408)—Aj sends Mi to Bi and requests that Bi sign on Mi with the signing key Si.

Flow (1409)—Bi checks the bit length of Mi which should be less than or equal to 64 bits.

If Mi is greater than 64 bits, then this operation should be performed in Mode 4.

Flow (1410)—Bi jumps to flow (902) in order to initiate user logon.

Flow (1412)—Bi checks the value of the Mode 3 Counter G3. This should be G3 max (=1) after Flows (902) through (915).

Flow (1414)—Mi is signed with Si using
Ui=Si{Mi}. formula (219)

Flow (1415)—the value of the G3 counter is reduced by 1 so that G3 becomes 0 in this case.

Flow (1416)—Bi returns Ui and the certificate LVi to Aj.

Flow (1417)—Aj verifies LVi and Ui using
Vo{LVi}→Ni, Vi, TV formula (210)
and
Vi{Ui}→Mi formula (220)

Flow (1418)—Aj sends the result to Bi: Accepted or Denied depending on the result of Flow (1417).

Mode 4 Payment/Authorization

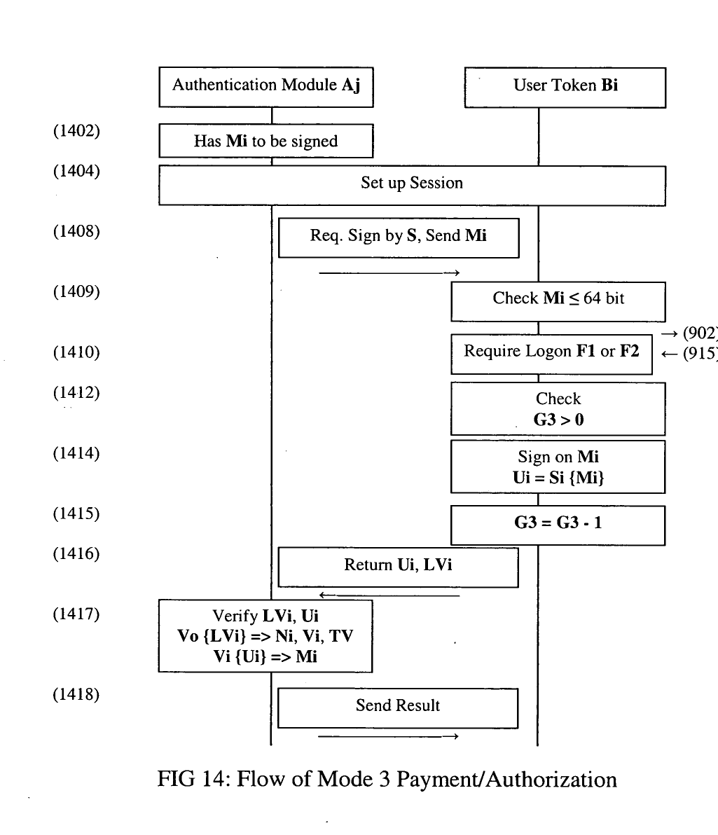

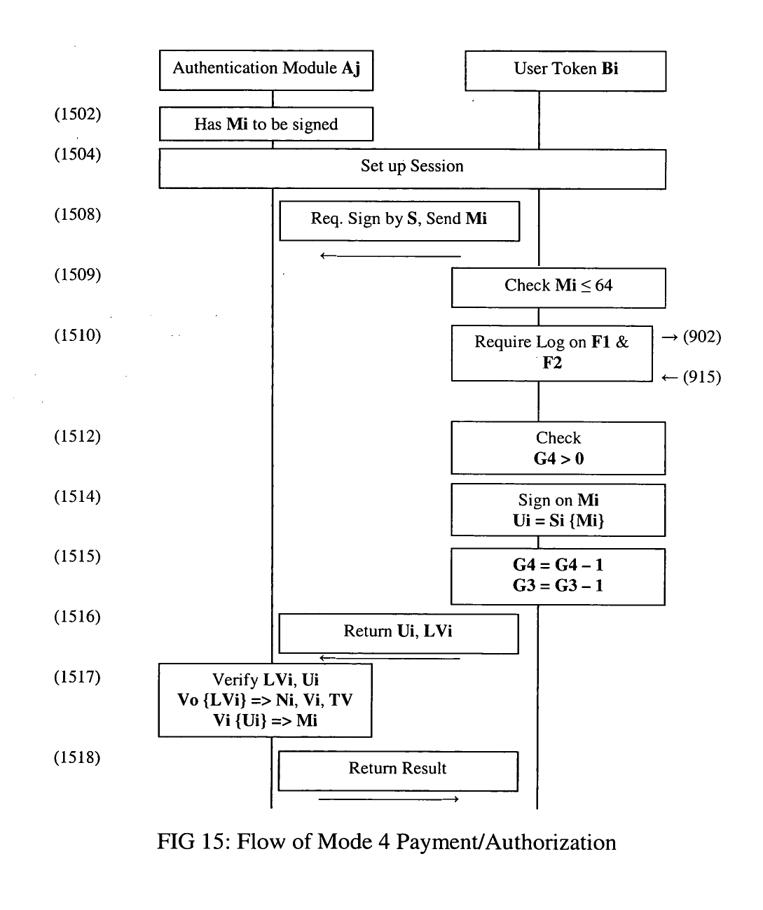

Mode 4 is used for the applications that require the highest levels of security such as authorization of a large payment or of an important document such as a contract. The flow of FIG. 15 is as same as in FIG. 14. The only differences are that two logons by F1 and F2 are required instead of one as in Flow (1510), G4 is used instead of G3 as in Flow (1512), and both the G3 and G4 counters are cleared.

Administrator Mode

In addition to the above user modes available in a Multi-Mode Token, an administrator mode can be added, in which only an administrator or the Authenticator Ao at System Authority can initiate the mode in order to modify system properties such as the value of G max, the Expiration period, etc.

The User Token Bi can authenticate the legitimacy of Ao or Aj via the standard challenge/response procedure using Vo.

1. In a user device which communicates with system terminals on behalf of its owner and has authentication means for user logon, the improvement wherein said token has at least one mode in which a user is exempt from said logon for a predefined period, and includes functions to obtain the present date and/or time from said terminal in order to check for expiration based on said predefined period,
whereby said user can adjust the required logon frequency depending on the security level desired for token operations.

2. In a user device which communicates with system terminals on behalf of its owner and has authentication means for user logon, the improvement wherein said token has at least one mode in which a user is exempt from said logon for a predefined number of a specified operation, and includes a counter in order to count said number of said specified operation,
whereby said user can adjust the required logon frequency depending on the security level desired for token operations.

3. A digital communication system comprising:
(a) providing at least one system terminal,
(b) providing at least one user token which has authentication means for user logon,
(c) said system terminal requesting certain operations from said user token and providing the information of the present date and/or time,
(d) said user token performing said operations on behalf of said user after said user logon,
(e) said user token having at least one mode in which user is exempt from said logon for a predefined period and having functions to obtain said information of the present date and/or time from said terminal and check for expiration using said information of the present date and/or time and the latest logon date and/or time stored.

4. A digital communication system comprising:
(a) providing at least one system terminal,
(b) providing at least one user token which has authentication means for user logon,
(c) said system terminal requesting certain operations from said user token,
(d) said user token performing said operations on behalf of said user after said user logon,
(e) said user token having at least one mode in which said user is exempt from said logon for a predefined number of said specified operations and having a counter and checking said predefined number of specified operation by said counter.
